(19) United States
(12) Patent Application Publication
(10) Pub. No.: US 2011/0225138 A1
(43) Pub. Date: Sep. 15, 2011

(54) APPARATUS FOR RESPONDING TO A SUSPICIOUS ACTIVITY

(76) Inventor: Michael Johnston, Gourock (GB)

(21) Appl. No.: 13/122,031

(22) PCT Filed: Oct. 2, 2009
(86) PCT No.: PCT/GB2009/051300

§ 371 Date: May 26, 2011

(30) Foreign Application Priority Data
Oct. 2, 2008 (GB) 0818036.6

(51) Int. Cl. G06F 17/30; G06F 7/00

(52) U.S. Cl. 707/706; 707/769; 707/723; 707/731; 707/E17.014; 707/E17.108

(57) ABSTRACT

An apparatus adapted to process and store data relating to a suspicious activity, the apparatus comprising: inputting means for inputting the data; a memory for storing the data; and a processor for processing the data and storing the data to memory, wherein the processor is adapted to match the inputted data with existing data which has previously been stored to memory or existing data stored at another source.

The present invention relates to a method and apparatus for responding to a suspicious activity or for responding to a request for consent in relation to a financial transaction. In particular, but not exclusively, the invention relates to an apparatus for initiating, matching, searching, and/or prioritising information within a Suspicious Activity Report (SAR) or a Consent request or a network for directing or co-ordinating the information.

Many countries, such as the UK and the US, now have laws which oblige Financial Service Providers (FSPs) to submit a SAR in response to a known or suspected criminal activity. This is to counter the increasing threat from terrorist activities, organised crime and the like. Similarly, the FSP must submit a Consent request to a government agency such as when an individual or organisation seeks to perform something that the FSP is suspicious of, for instance, withdrawing a large sum of money from their account.

The number of SARs in the UK has increased from 20,000 in 2000 to 250,000 in 2006. In the USA, the annual number of SARs is approximately 10 times this number (although US SARs typically relate to a single transaction, while UK SARs contain many transactions). However, given that SARs and Consents originate from a wide diversity of sources, the formatting and method of submission of these SARs and Consents has been very inconsistent. For these and other reasons, some of which are explained below, the result has been that only a small percentage of the submissions have been properly processed and investigated. It is desirable that improved methods or apparatus be provided to increase the number of submissions that are processed and investigated. It is desirable that the improved methods or apparatus are adapted to better accommodate inconsistencies in the formatting of submissions.

Currently, when a SAR is added to a database of existing SARs, no comparison is made between data within the SAR being added and existing data. Any correlations can only be found when a search is performed. But such a search requires prior knowledge of which SARs to compare and how the data may be correlated. It is desirable to provide a system which matches data within the SAR being added to data within existing SARs, or within other sources. It is desirable to provide a system which matches data within the SAR being added at the time of adding the SAR.

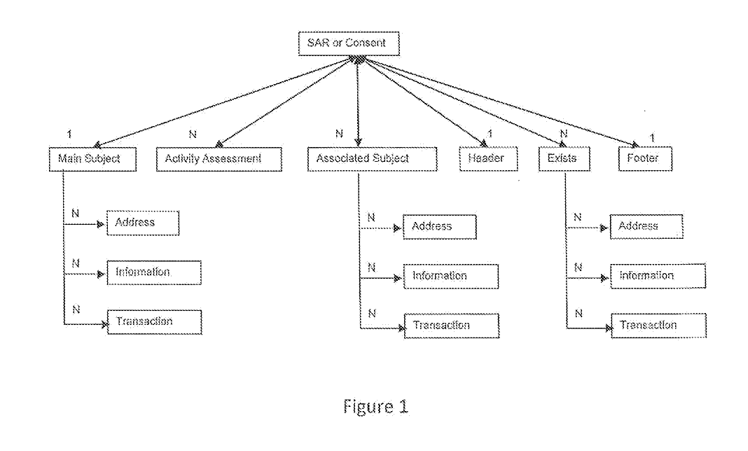

FIG. 1 shows the generic structure of a SAR or Consent. The information is related, and these relationships have to be preserved when processing a SAR or Consent. Each SAR or Consent includes structured text fields, such as a person's name contained in the fields of title, first name, middle name, and surname. However, the information may not be inputted in the correct field, or may be misspelled, and this is more likely to occur with foreign names. Similarly, with address fields, information can be inputted in the wrong field and the information can be incomplete or wrong. Also, it is known that individuals wishing to avoid detection have intentionally changed the order of their name, address or other data.

It is desirable to provide a method or apparatus for searching and matching that better accommodates incomplete, incorrect, wrongly ordered or wrongly placed information. Some database systems use data scrubbing techniques on an intermittent basis to ‘clean’ the data, which can involve correcting typographical errors or moving data to different fields. However, to ensure that a particular search produces accurate results, it is desirable that the searching or matching technique itself accommodates incomplete, incorrect, wrongly ordered or wrongly placed information.

Each SAR or Consent also includes unstructured free format text fields. In a SAR there are many free text fields where the reporter may input any related information. For example, in the “reason for suspicion” field, the reporter may input the reason why the SAR has been initiated. This inputted information may contain general descriptive text as well as items such as email addresses, passport numbers, and the like. This complicates the task of searching and matching due to the completely free format and unstructured volume of information. Also, in the future there may be fields containing multi-media or biometric information such as video clips, audio tracks, iris scan, finger print, and so on. It is desirable to provide a method or apparatus for searching and matching that accommodates the unstructured format of these fields in the SAR or Consent or a diverse range of field content.

When a small number of documents are being searched, it is possible to perform a full text search to directly scan the contents. However, when a large database or a large number of documents are being searched, it is common to using indexing. During indexing, a list of search terms is built and, when a search is carried out, only the index is referenced rather than the original data. Typically, many pieces of text are deemed to be stop words or noise words, and this text is omitted when the index is created. While this improves the speed of the search, the possibility of missing relevant data also increases. Given the serious nature of SARs, it is important to ensure as far as possible that no relevant data is missed. In particular, given the unstructured free format text fields that each SAR contains, many words which could be treated as a stop word may actually be relevant. It is desirable to provide an alternative searching or matching process which can search all data within a practical searching time.

A typical searching engine allows a user to specify search terms and other parameters to find relevant documents or data. When the set of documents found using these parameters is still too great, many engines allow the user to carry out a sub-search within this set of documents using other parameters to further limit the number of documents found. However, if one of the original parameters used is incorrect, it may not find a relevant document within the first set of documents found, and any further sub-searches will also not find this relevant document. Keeping track of which search or sub-search has produced a particular set of results can be difficult for a user.

At present, a SAR has a typical life-cycle. The FSP detects a suspicious activity and generates a SAR. The SAR is submitted to a national body responsible for collating SARs, called a Financial Intelligence Unit (FIU), such as SOCA in the UK. The FIU then sends the SAR out to a suitable investigating agency, such as a police department or government agency. The agency selected depends on the nature of the suspicious activity. The agency investigates the suspicious activity and processes the SAR.

This typical SAR life-cycle has a number of disadvantages or limitations. As explained above, the SAR generation is error prone. Also, a number of FSPs report little or no SARs. The existing system for importing SARs to the FIU in the UK and other countries is complex. Furthermore, the FIU receives no feedback from the agencies once the SAR has been processed. Similarly, the FSP receives no feedback from the FIU. Feedback is important for a number of reasons. For instance, feedback would help the various bodies to improve their systems and procedures. Also, government bodies oversee and fund the FIU and they require regular management information reports to assist in supervision and to justify the funding. FSPs would also benefit from similar reports to improve their approach to creating and submitting SARs.

The investigating agencies receiving a SAR or Consent require means to prioritise, cross-match new SARs against a variety of data sources, search against wanted lists and so on. For instance, different investigating agencies will have different priorities depending on their function. However, the existing system does not allow SARs to be prioritised based on the function of the investigating agency.

It is desirable to provide a federated system where two or more systems co-operate for the purposes of the SAR or Consent life-cycle. This enhancement would allows some or all of the various bodies involved in the life-cycle to make use, and take advantage, of their own systems for as much or as little of the life-cycle as they wish, rather than having to rely solely on a centralised system. For example, a particular body may wish to use a different set of historical SARs when cross-matching, or make use of a different scoring policy. Yet, in a suitable system, the bodies would be able to co-operate and achieve their particular tasks or goals within the life-cycle.

It is desirable to provide an improved method of prioritising the SARs generated and of allocating the SARs to the most appropriate agency.

The existing SAR system also does not allow for automatic selection of the most suitable body to process or investigate the SAR, or for automatic filtering of sensitive information before sending to the body, the level of filtering being appropriate for that body.

According to a first aspect of the present invention there is provided an apparatus adapted to process and store data relating to a suspicious activity, the apparatus comprising:
inputting means for inputting the data;
a memory for storing the data; and
a processor for processing the data and storing the data to memory,
wherein the processor is adapted to match the inputted data with existing data which has previously been stored to memory or existing data stored at another source.

The processor may be adapted to access existing data stored at a source external to the apparatus to perform the match. The external source may comprise a database or a file. Alternatively or in addition, the inputting means may be adapted to allow the inputting of a batch of data relating to a suspicious activity and the processor may be adapted to match data being added with data contained in the batch of data.

The processor may be adapted to match the inputted data with existing data at the time of adding the inputted data.

The apparatus may be adapted to allow a user to specify the matching criterion used by the processor. The matching criterion may comprise one or more of a main subject, an associated subject, a financial account number, or a subject identifier such as a passport number, telephone number or email address.

The apparatus may be adapted to match data in a first field of the inputted data with data in a second field of the existing data.

The processor may be adapted to perform an exact match of inputted data with existing data. Alternatively or in addition, the processor may be adapted to match data that meets one or more similarity criteria. The or each similarity criterion may comprise a fuzzy start or end or text, phrasing, data proximity, status, a date or date range, synonyms, inflectional wording or geographical proximity.

The apparatus may be adapted to assign a score to the inputted data based upon the degree of matching with existing data. The score may be determined using one or more factors. The or each factor may comprise a financial value relating to the inputted data, a total financial value relating to both the inputted data and matched existing data, the type of match such as whether it is a match of the main subject, an associated subject, a financial account number, or a subject identifier, the exactness of the match or the degree of risk such as a match for the reason for suspicion.

The apparatus may be adapted to prioritise the inputted data based upon the degree of matching with existing data. The apparatus may be adapted to prioritise the inputted data based upon the assigned score.

The apparatus may be adapted to transmit or display matched data to one or more users. The matched data may be transmitted or displayed in the order of the assigned score, asset value, age or status. The apparatus may be adapted to categorise matched data by how the data is matched. The apparatus may be adapted to transmit or display matched data to a user based on the category of the matched data and a designation of the user. The designation of the user may relate to one or more of the user's access level, level of authority, or function.

The inputting means may be adapted to receive structured data. The processor may be adapted to process the structured data to denormalise the data. Denormalising the data may comprise generating one or more data strings corresponding to the structured data. Denormalising the data may include preserving the relationships of the structured data. The processor may be adapted to delete duplicate data strings. The denormalised data may be stored to memory. The denormalised data may be stored within optimised tables in memory. The processor may be adapted to carry out a full text catalog search to match inputted data with existing data.

The inputting means may be adapted to receive unstructured free text data. The processor may be adapted to use regular expressions to extract tokens from the unstructured free text data. The processor may be adapted to delete duplicate tokens. The tokens may be stored to memory. The tokens may be stored within optimised tables in memory. When searching against unstructured free text fields, the entire free text field may be stored in a special structure which has an associated full-text catalog. This allows searches to find phrases.

The apparatus may include a search engine for searching existing data. The search engine may be adapted to search structured or unstructured data. The search engine may be adapted to denormalise the data. Denormalising the data may comprise generating one or more data strings corresponding to the structured data. Denormalising the data may include preserving the relationships of the structured data. The denormalised data may be stored to memory.

The denormalised data may be stored within optimised tables in memory. The search engine may be adapted to carry out a full text catalog search to match inputted data with existing data.

The search engine may be adapted to allow search criteria to be entered in any order. The search engine may be adapted to allow the searching of existing data stored at another source.

The search engine may be adapted to allow a first search to be carried out using a first criterion to produce a first set of results, and to allow one or more second searches to be carried out on the first set of results using a second criterion to produce a second set of results. The search engine may be adapted to allow one or more subsequent searches to be carried out on the second set of results using one or more third criteria to produce one or more third sets of results.

The search and/or associated criterion may be displayed to the user in a manner that indicates the relationship between the searches. The search and/or associated criterion may be displayed to the user as a tree structure. The tree structure may be navigable by the user to display the results of a user selected search and/or criterion.

The processor of the apparatus may be remote from the memory of the apparatus. The apparatus may be provided on a network. The network may comprise a plurality of nodes, each node having an associated memory. The processor may be adapted to access the memory of a node and perform the matching of data at the node. This avoids the need to transmit large volumes of data to the node which includes the processor.

The network may comprise one or more financial service providers, a Financial Intelligence Unit and a plurality of investigative agencies. The network may be adapted to allow the or each financial service provider to generate and transmit a suspicious activity report or a consent request to the Financial Intelligence Unit. The network may be adapted to allow the Financial Intelligence Unit to process the suspicious activity report or a consent request and then transmit the suspicious activity report or a consent request to an appropriate investigative agency.

The network may be adapted to allow the plurality of investigative agencies to share data relating to a suspicious activity report or a consent request. The network may be adapted to allow an investigative agency to generate an investigative report relating to the suspicious activity report or a consent request and to transmit the investigative report to the Financial Intelligence Unit.

The network may be adapted to allow the Financial Intelligence Unit to transmit the investigative report to the financial service provider that submitted the suspicious activity report or a consent request. The network may be adapted to filter the investigative report before transmittal to the financial service provider. The network may be adapted to generate one or more auditing reports based upon the received suspicious activity reports or a consent requests.

The network may include one or more closed user groups. The network may be adapted to transmit data relating to one or both of the suspicious activity report or consent request and the investigative report to a closed user group.

The network may comprise the proprietary computer systems, databases or files of one or more of the financial service providers and investigative agencies. The network is therefore a federated system. Alternatively or in addition, the network may comprise a centralised system which is accessible by the financial service providers, Financial Intelligence Unit and the investigative agencies. The network may comprise a centralised portion and a federated portion.

According to a second aspect of the present invention there is provided an apparatus adapted to process and store data relating to a suspicious activity, the apparatus comprising:
inputting means for inputting the data;
a memory for storing the data; and
a search engine for searching stored data,
wherein the search engine is adapted to denormalise the data to generate one or more data strings corresponding to the structured data and to subsequently carry out a full text catalog search of the or each data string.

The search engine may be adapted to search structured or unstructured data. Denormalising the data may include preserving the relationships of structured data. The denormalised data may be stored to memory. The denormalised data may be stored within optimised tables in memory.

The search engine may be adapted to allow search criteria to be entered in any order. The search engine may be adapted to allow the accessing and searching of existing data stored at an external source. The external source may comprise a database or a file.

The search engine may be adapted to allow a first search to be carried out using a first criterion to produce a first set of results, and to allow one or more second searches to be carried out on the first set of results using a second criterion to produce a second set of results. The search engine may be adapted to allow one or more subsequent searches to be carried out on the second set of results using one or more third criteria to produce one or more third sets of results. There may be no limit to the number of search levels.

The search and/or associated criterion may be displayed to the user in a manner that indicates the relationship between the searches. The search and/or associated criterion may be displayed to the user as a tree structure. The tree structure may be navigable by the user to display the results of a user selected search and/or criterion.

The search engine may be adapted to perform an exact search of existing data. Alternatively or in addition, the search engine may be adapted to find data that meets one or more similarity criteria. The or each similarity criterion may comprise a fuzzy start or end or text, phrasing, data proximity, status, a date or date range, synonyms, inflectional wording or geographical proximity.

The search engine of the apparatus may be remote from the memory of the apparatus. The apparatus may be provided on a network. The network may comprise a plurality of nodes, each node having an associated memory. The search engine may be adapted to access the memory of a node and perform the search of data at the node.

The network may comprise one or more financial service providers, a Financial Intelligence Unit and a plurality of investigative agencies. The network may comprise the proprietary computer systems, databases or files of one or more of the financial service providers and investigative agencies. Alternatively, the network may comprise a centralised system which is accessible by the financial service providers, Financial Intelligence Unit and the investigative agencies.

According to a third aspect of the present invention there is provided a network adapted to allow the initiation, processing, sharing and storing of data relating to a suspicious activity or consent request, the network comprising:
one or more financial service providers, a Financial Intelligence Unit and a plurality of investigative agencies,
wherein the network is adapted to allow the or each financial service provider to generate and transmit a suspicious activity report or a consent request to the Financial Intelligence Unit,
and wherein the network is adapted to allow the Financial Intelligence Unit to process the suspicious activity report or consent request and then transmit the suspicious activity report or consent request to an appropriate investigative agency,
and wherein the network is adapted to allow an investigative agency to generate an investigative report relating to the suspicious activity report or consent request and to transmit the investigative report to the Financial Intelligence Unit,
and wherein the network is adapted to allow the Financial Intelligence Unit to transmit the investigative report to the financial service provider that submitted the suspicious activity report or consent request.

The network may be adapted to allow the plurality of investigative agencies to share data relating to a suspicious activity report or a consent request.

The network may be adapted to filter the investigative report before transmittal to the financial service provider. The network may be adapted to generate one or more auditing reports based upon the received suspicious activity reports or consent requests.

The network may include one or more closed user groups. The network may be adapted to transmit data relating to one or both of the suspicious activity report or consent request and the investigative report to a closed user group.

The network may comprise the proprietary computer systems, databases or files of one or more of the financial service providers and investigative agencies. Alternatively, the network may comprise a centralised system which is accessible by the financial service providers, Financial Intelligence Unit and the investigative agencies.

The network may include a processor adapted to match inputted data with existing data which has previously been stored to memory or existing data stored at another source. The network may be adapted to access existing data stored at a source external to the apparatus to perform the match.

The network may be adapted to assign a score to inputted data based upon the degree of matching with existing data. The score may be determined using one or more factors. The or each factor may comprise a financial value relating to the inputted data, a total financial value relating to both the inputted data and matched existing data, the type of match such as whether it is a match of the main subject, an associated subject, a financial account number, or a subject identifier, the exactness of the match or the degree of risk such as a match for the reason for suspicion.

The network may be adapted to prioritise the inputted data based upon the degree of matching with existing data. The network may be adapted to prioritise the inputted data based upon the assigned score.

The network may be adapted to transmit or display matched data to one or more users. The matched data may be transmitted or displayed in the order of the assigned score. The apparatus may be adapted to categorise matched data by how the data is matched. The apparatus may be adapted to transmit or display matched data to a user based on the category of the matched data and a designation of the user. The designation of the user may relate to one or more of the user's access level, level of authority, or function.

The network may include a search engine for searching existing data. The search engine may be adapted to denormalise the data to generate one or more data strings corresponding to the data. The search engine may be adapted to carry out a full text catalog search on the data.

The network may comprise a plurality of nodes, each node having an associated memory. The processor may be adapted to access the memory of a node and perform the matching of data at the node.

According to a fourth aspect of the present invention there is provided an apparatus adapted to process and store data relating to a suspicious activity, the apparatus comprising:
inputting means for inputting the data;
a memory for storing the data; and
a processor for processing the data and storing the data to memory, the processor being adapted to match the inputted data with existing data,
wherein the apparatus is adapted to assign a score to the inputted data based upon the degree of matching with existing data,
and wherein the apparatus is adapted to prioritise the inputted data based upon the assigned score.

The score may be determined using one or more factors. The or each factor may comprise a financial value relating to the inputted data, a total financial value relating to both the inputted data and matched existing data, the type of match such as whether it is a match of the main subject, an associated subject, a financial account number, or a subject identifier, the exactness of the match or the degree of risk such as a match for the reason for suspicion.

The apparatus may be adapted to transmit or display matched data to one or more users. The matched data may be transmitted or displayed in the order of the assigned score. The apparatus may be adapted to categorise matched data by how the data is matched. The apparatus may be adapted to transmit or display matched data to a user based on the category of the matched data and a designation of the user. The designation of the user may relate to one or more of the user's access level, level of authority, or function.

The processor may be adapted to access existing data stored at a source external to the apparatus to perform the match. The external source may comprise a database or a file. Alternatively or in addition, the inputting means may be adapted to allow the inputting of a batch of data relating to a suspicious activity and the processor may be adapted to match data being added with data contained in the batch of data.

The processor may be adapted to match the inputted data with existing data at the time of adding the inputted data.

The apparatus may be adapted to allow a user to specify the matching criterion used by the processor. The matching criterion may comprise one or more of a main subject, an associated subject, a financial account number, or a subject identifier such as a passport number, telephone number or email address.

The apparatus may be adapted to match data in a first field of the inputted data with data in a second field of the existing data.

The processor may be adapted to perform an exact match of inputted data with existing data. Alternatively or in addition, the processor may be adapted to match data that meets one or more similarity criteria. The or each similarity criterion may comprise a fuzzy start or end or text, phrasing, data proximity, status, a date or date range, synonyms, inflectional wording or geographical proximity.

An embodiment of the present invention will now be described by way of example only with reference to the accompanying drawings in which:

FIG. 1 is a diagram of the generic structure of a SAR or Consent;

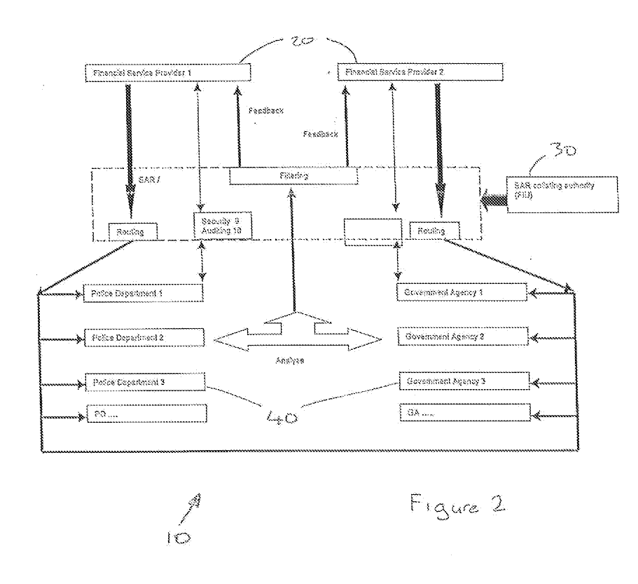

FIG. 2 is a diagram of a network according to the present invention;

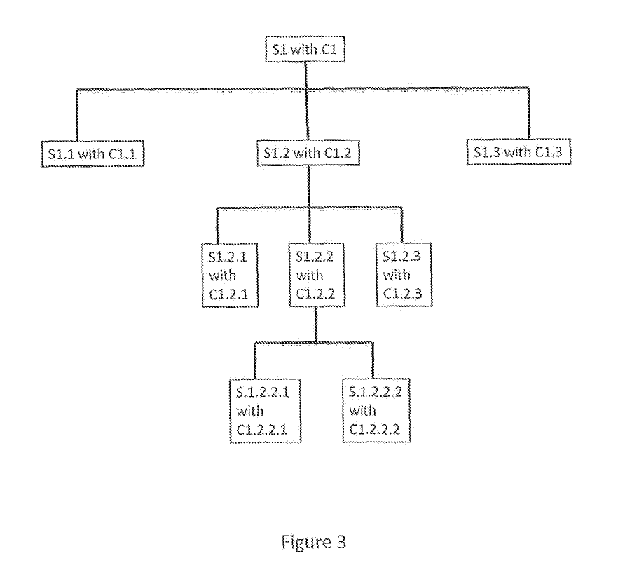

FIG. 3 is a diagram of a search tree structure displayed to a user during a search.

FIG. 1 shows the generic structure of a SAR or Consent. Textual information within a SAR can be classified into elemental types which can be treated independently and scored independently.

The main subject contains information about the main subject of the SAR such as a person or company name and all known addresses.

The associated subject contains information about all associated subjects of the SAR such as a person or company name and all known addresses.

The information element is one or more free text unstructured fields which contain information about the main or associated subjects of the SAR.

Transactions fields are structured fields which contain transactional information as well as also containing unstructured fields containing information about people, companies and so on associated with that particular transaction.

The reason for suspicion field is an unstructured free format field containing information justifying why the SAR was raised, and containing any other relevant pieces of information.

FIG. 2 shows a network 10 which allows the initiation, processing, sharing and storing of data relating to a suspicious activity (SAR) or Consent. The network 10 comprises a number of financial service providers (FSPs) 20, such as banks, in communication via the network 10 with a Financial Intelligence Unit (FIU) 30. Also in communication via the network 10 with the FIU 30 are a number of investigative agencies 40, such as police departments or government agencies.

Each FSP 20 can generate and transmit a SAR or Consent via the network 10 to the FIU 30 for processing. This processing involves matching the data in the transmitted SAR or Consent with existing data which has previously been stored to memory or existing data stored at an external source. The external source could be a database or a file belonging to one of the investigative agencies 40, such as a police wanted or missing file, or another source such as a Bank of England sanctions file. Also, the SARs or Consents can be processed in batches and the network allows the matching of data with data contained in a batch. The matching of data can be performed at the time of adding the inputted data. Alternatively, the matching can be scheduled to be done at specified times. Also, it can be specified that new SARs or Consents are processed in defined chunks to reduce the load on the operating system.

A user may specify the matching criterion used. For instance, the user could specify that matching is carried out only for the main subject of a SAR or Consent, or for an associated subject, or a financial account number, or a subject identifier such as a passport number, telephone number or email address. Alternatively, the user can specify a particular combination of these criteria. It can also be specified that data in a first field is matched with data in one or more other fields of the existing data.

In a preferred embodiment, there are seven different categories of matching. Each can be assigned its own score and each can be turned on or off. The seven categories are described below.

For a main subject category, the matching engine looks at data related to a SAR's main subject, which could be a person or a company. Figure one shows that a main subject has main subject specific data such as name, date of birth, company name, company number and so on A main subject also has address, information and transactional data. Some data is structured and some is unstructured.

Thus the matching engine looks to find any other SARs in the system or even in the same batch that have the “same data”. The system could be a federated system where SARs can be on different physical machines.

“Sameness” is controllable through exact or fuzzy, whether or not vowels are ignored when fuzzy matching, and the degree of fuzziness (between 1% and 100%). However the data to match against is restricted to main subject name or company details and all addresses. There is the option to match main subject names and addresses against associated subject names and addresses.

For the associated subject matching category, the matching engine looks at data related to a SAR's associated subjects. A SAR may have many such associated subjects. An associated subject could be a person or a company. Figure one shows that an associated subject has associated subject specific data such as name, date of birth, company name, company number and so on. An associated subject also has address, information and transactional data. Some data is structured and some is unstructured.

Thus the matching engine looks to find any other SARs in the system or even in the same batch that have the “same data”. The system could be a federated system where SARs can be on different physical machines.

“Sameness” is again controllable through exact or fuzzy, whether or not vowels are ignored when fuzzy matching, and the degree of fuzziness (between 1% and 100%). However, the data to match against is restricted to all associated subjects; name or company details and all addresses. There is the option to match associated subject names and addresses against main subject names and addresses.

For transactional matching, the matching engine is concerned about transactional information. Some of this is structured, such as. account numbers, and some of this is unstructured, since. there are a number of free text fields associated with a transaction.

Regular expressions are used to extract items of interest such as bank account numbers, passport numbers, and email addresses from unstructured free text fields in a transaction.

Thus the matching engine looks to find any other SARs in the system or even in the same batch that have the “same data” in their transactions. The system could be a federated system where SARs can be on different physical machines. There is the option of matching against data found in the rest of a SAR. For instance, a bank account number is supplied in this SARs transaction, and the same bank account number may feature in a different SAR's reason for suspicion field or information field.

The fourth matching category is information matching. The matching engine is concerned about information supplied by the FSP about the subjects. Some of the information is structured, such as unique identification number like a passport number or driving license number, and some of the information is unstructured, such as a free text field to allow any other relevant information to be stored.

Regular expressions are used to extract items of interest such as bank account numbers, passport numbers, and email addresses from unstructured free text fields in a transaction.

Thus the matching engine looks to find any other SARs in the system or even in the same batch that have the “same information data”. The system could be a federated system where SARs can be on different physical machines. There is the option of matching against data found in the rest of a SAR. For instance, a bank account number is supplied in this SARs information field, and the same bank account number may feature in a different SAR's reason for suspicion field or transaction field.

For reason for suspicion matching, the reason for suspicion field is located in the SAR header and is a completely unstructured free format field.

For the purpose of matching only, regular expressions are used to extract items such as; passport numbers, email addresses, ip addresses, bank account numbers and so on.

Thus the matching engine looks to find any other SARs in the system or even in the same batch that have the “same data” in the reason for suspicion field. The system could be a federated system where SARs can be on different physical machines. There is the option of matching against data found in the rest of a SAR. For instance, a bank account number is supplied in this SARs reason for suspicion field, and the same bank account number may feature in a different SAR's transaction or information field.

The previous five categories focus on matching data in one SAR against data in other SARs. The subject of interest matching category allows a SAR to be matched against data that is independent from the SARs database. Thus there may be a list of names, addresses and so on. When a SAR is loaded in its details are matched against this list. The list may be locally stored or it may be remotely stored.

Reason for suspicion list matching also allows a SAR to be matched against data that is independent from the SARs database. There may be a list of pieces of information that is found in the reason for suspicion field. When a SAR is loaded in its details are matched against this list. This list may be locally stored or it may be remotely stored.

The user can request an exact match of inputted data with existing data or request that data is matched if the data meets one or more similarity criteria. These similarity criteria could be exactness of the match, phrasing, data proximity, status, a date or date range, synonyms, inflectional wording or geographical proximity.

Exactness relates to factors such as whether the match is exact, or whether data has a fuzzy start or end, or whether or not vowels are ignored. Phrasing relates to whether the data is phrased or not phrased. The data proximity can be ‘anywhere’, ‘near’ or ‘within’.

A date or date range can be taken into account, such as the date the SAR is loaded in, or the date the SAR is received by the FIU 30, or the date the SAR is reported.

Text can be compared with synonyms from a dynamic thesaurus. The inflection of text can be taken into account, such as where the different tenses of a verb or both the singular and plural forms of a noun are used when matching.

For geographical proximity, the user can define an area, such as within 200 m, and any addresses within this area are deemed to be the same address for the purposes of matching. The user may also opt to ignore any flat number or house number or even house name and simply use the street name.

For the matching process, structured data is treated differently from unstructured data. Structured data is first processed to denormalise the data which comprises generating one or more data strings corresponding to the structured data. However, this denormalising of the data preserves the relationships of the structured data. Duplicate data strings are deleted to avoid artificially high matching scores and the denormalised data is then stored to memory within optimised tables. These optimised search tables also contain meta-information about the SAR being added. This further helps in searching since meta-information can be used by the end user to restrict their search. The regular expressions are used to extract useful pieces of information such as; bank account numbers, amail addresses, ip addresses and so on from unstructured data. These useful pieces of information are stored in specially optimised search tables. These tables have the same meta-data that is used for structured data. However, unstructured data is stored “as-is” for the purposes of search, and only matching uses the extracted regular expressions. When searching, a user may be looking for phrases and so the entire unstructured field must be searched against.

For each SAR, the meta-information includes the SAR's number or ID, the current status, the SAR's assigned score, the SAR's asset value, the date the SAR was loaded into the system, the date the SAR was received from the reporting FIU 30, the date the SAR was sent to an investigating agency 40, the SAR's tag, a geographic location to which SAR belongs, the owner of the SAR, and any special permissions, such as whether the SAR can be searched against but cannot be viewed or whether any hits against this SAR must be reported to owner.

As an example, a SAR with the ID 112233 may include, along with 10 transactions and a large reason for suspicion field, two people and a company, each of which has 2 addresses:

John Smith 18/07/1965 residing at:
33 green law avenue Paisley pa12 3RG
45 ridgeway road Glasgow gr1 2rg
   Jane Jones 12/03/1970 residing at;
33 green law avenue Paisley
45 waterfront avenue Glasgow gr1 2rg

### Eagle Computers

22 waterfront avenue Glasgow gr1 2rg
45 waterfront avenue Glasgow gr1 2rg

Considering only the names and address that a user can search against, the system creates a specially optimised search table called SARSearchEntity. This has many columns for the meta-information as well as a column called SearchField. SearchField contains the joined up (in this case) names and addresses. The SearchField is too long to be a database index. Thus, for the names and address only, there would be six entries in SARSearchEntity for this SAR where the people and/or company have been joined up with their addresses:

John Smith 18/07/1965 33 green law avenue Paisley pa12 3RG
John Smith 18/07/1965 45 ridgeway road Glasgow gr1 2rg
Jane Jones 12/03/1970 33 green law avenue Paisley
Jane Jones 12/03/1970 45 waterfront avenue Glasgow gr1 2rg
Eagle Computers 22 waterfront avenue Glasgow gr1 2rg
Eagle Computers 45 waterfront avenue Glasgow gr1 2rg

When a standard search or match is carried out, similarity criteria can be accommodated using a T-SQL LIKE statement. LIKE cannot benefit from a database index (in fact it would not be sensible to even create one if it was possible because the SearchField column in the SARSearchEntity is too large).

Supposing the user has opted for a fully fuzzy search and has entered the search string:

jones jane 33 green law paisley 12/03/1970;

This would be converted into:

% jones % % jane% %33% %green% %law% %paisley% %12/03/1970%

The T-SQL query would then look like (have removed complexity when filtering by meta-information):

```
SELECT DISTINCT submissionName FROM SARSearchEntity
WHERE
    SearchField LIKE ‘%jones%’ AND
    SearchField LIKE ‘%jane%’ AND
    SearchField LIKE ‘%33%’ AND
    SearchField LIKE ‘%green%’ AND
    SearchField LIKE ‘%law%’ AND
    SearchField LIKE ‘%paisley%’ AND
    SearchField LIKE ‘%12/03/1970%’
GO
```

This could have been treated as a phrase (this is usually done when searching unstructured fields rather than when searching names and addresses). However the syntax would be:

USE <system name>
GO
SELECT DISTINCT submissionName FROM SARSearchEntity
WHERE
SearchField LIKE ‘%jones jane 33 green law paisley 12/03/1970%’
GO

The LIKE statement is necessary to support regular expressions. Because the LIKE statement is being used, the search has to consider every row in the SARSearchEntity table. A typical search may take up to 4 minutes to search through 1.5 million entries.

It is to be noted that the first name and surname name were entered in a different order and the date of birth was placed at the end. Yet this search would still find the relevant SAR. Also, a regular expression could have been used to find ‘jane’ who was born between two dates. Also, wildcarding is used at the start and end of every word.

When an express search or match is carried out, to focus on speed rather than functionality, the user can make use of Full-Text Search. Usually if one had a Word, Excel, Acrobat file or the like that has been stored in an image date type then a full text catalog could be created and a search performed against it. This full text catalog is not part of the SQL Server database. If an index is created on a column in a database table then that index is stored in the database. Full text catalogs are stored on a separate physical device to the database.

A full-text index is a special type of token-based functional index that is built and maintained by the Microsoft Full-Text Engine for SQL Server (MSFTESQL) service. The process of building a full-text index is quite different from building other types of indexes. Instead of constructing a B-tree structure based on a value stored in a particular row, MSFTESQL builds an inverted, stacked, compressed index structure based on individual tokens from the text being indexed.

It is necessary to create a full-text catalog and define which columns and table it is to be created from:

```
USE <system name>
GO
EXEC sp_fulltext_database ‘enable’
GO
IF EXISTS (SELECT * FROM sys.fulltext_indexes fti
WHERE fti.object_id =
OBJECT_ID(N‘[dbo].[SARSearchEntity]’))
BEGIN
    ALTER FULLTEXT INDEX ON [dbo].[SARSearchEntity]
DISABLE
END
GO
IF EXISTS (SELECT * FROM sys.fulltext_indexes fti
WHERE fti.object_id =
OBJECT_ID(N‘[dbo].[SARSearchEntity]’))
BEGIN
    DROP FULLTEXT INDEX ON [dbo].[SARSearchEntity]
END
GO
IF EXISTS (SELECT * FROM sysfulltextcatalogs ftc WHERE ftc.name =
N‘PantherSearchCatalog’)
BEGIN
    DROP FULLTEXT CATALOG [PantherSearchCatalog]
END
--
-- CREATE new [SARSearchCatalog] and create index on
SARSearchEntity
--
CREATE FULLTEXT CATALOG [PantherSearchCatalog]
    IN PATH N‘E:\PantherFullTextCatalogs’
    WITH ACCENT_SENSITIVITY = OFF AUTHORIZATION [dbo]
CREATE FULLTEXT INDEX ON SARSearchEntity
    ( searchField LANGUAGE English ) KEY INDEX
    PK_SARSearchEntity
    ON PantherSearchCatalog WITH CHANGE_TRACKING AUTO
GO
```

As a result of this, a full-text catalog is created on the SearchField column of the SARSearchEntity table. This is stored in E:\FullTextCatalogs directory. Suppose the user has opted for a fully fuzzy search and has entered the search string:

jones jane 33 green law paisley 12/03/1970

This would be converted into:

Jones* AND jane* AND 33* AND green* AND law* AND paisley* AND 12/03/1970*

On a typical search, the user now waits less than 2 seconds rather than 4 minutes when searching through 1.5 million entries. This is because the full-text catalog structure is optimised for searching. Indeed it is up to a 1,000 times faster than using LIKE. Other advantages are that other connectives such as OR and NOT can be used, and SARs can be found even when data is put in the wrong place. There is also complete control over the stop words. The default stop list can be used, or no stop words may be used, or a customised domain specific stop list can be used.

The database query is now:

```
USE <system name>
GO
SELECT DISTINCT submissionName FROM SARSearchEntity
WHERE CONTAINS(
    SearchField,
    ‘Jones* AND jane* AND 33* AND green* AND law* AND paisley*
AND 12/03/1970*’)
GO
```

This could have been treated as a phrase (this is usually done when searching unstructured fields rather than when searching names and addresses). However the syntax would be:

```
USE Panther
GO
SELECT DISTINCT submissionName FROM SARSearchEntity
WHERE CONTAINS(
    SearchField,
    ′″Jones* AND jane* AND 33* AND green* AND law* AND
paisley* AND 12/03/1970*′″)
GO
```

The processor of the network therefore carries out a full text catalog search to match inputted data with existing data. A full text catalog search is typically used to scan documents such as Word, Excel or Adobe files. However, it has been found that, by first denormalising the data to create data strings, and then carrying out the full text catalog search, rapid searches of all data can be performed.

Unstructured free text data for the purpose of matching is processed using dynamic regular expressions to extract tokens from the data. Duplicate tokens are deleted before the tokens are stored to memory within optimised tables. The dynamic regular expressions can be added to, edited or removed. As SARs are loaded in, the unstructured free format fields are parsed for patterns matching the regular expressions.

A score is assigned by the system to the inputted data based upon the degree of matching with existing data. This score is determined using one or more factors which can include a financial value relating to the inputted data, or a total financial value relating to both the inputted data and matched existing data, or the type of match such as whether it is a match of the main subject, an associated subject, a financial account number, or a subject identifier, or the exactness of the match, or the degree of risk such as a match for the reason for suspicion.

The SAR or Consent can be prioritised and allocated based upon the assigned score or can be allocated based on geographic location of SAR. The SAR or Consent is then transmitted to an appropriate investigative agency 40, the agency 40 being selected based upon the priority level and a categorisation of the type of investigation required, or based on geographic location.

The investigative agency 40 will carry out an investigation and then generate an investigative report. This report can then be transmitted to the FIU 30. The FIU 30 can then filter the report to remove any sensitive information and then transmit the filtered report to the FSP 20 that submitted the SAR or Consent. The network 10 also allows the FIU 30 to generate auditing reports based upon all or specified SARs or Consents that have been received.

The network 10 therefore provides full feedback from the investigative agencies 40 to the FIU 30. Also, feedback (filtered information) is provided to the FSP 20. This is important for continuous improvement of the overall system.

The network 10 also allows the various investigative agencies 40 to share data to assist in their investigations. Also, the network can include one or more closed user groups that have access (restricted or otherwise) to the network. Closed user groups can occur at or between any levels, such as for the FSPs 20, within the FIU 30, or between investigative agencies 40. The only restriction would be a legal one and not a technical one. The closed user groups could be horizontal groups, such as between investigative agencies 40, or vertical groups. Filtering of the data to be shared can be used, especially in the case of vertical groups. International co-operation is increasingly necessary. A closed user group could exist for the different police departments or other investigative agencies 40 of different countries.

Members of these closed user groups could also be accountants or stockbrokers or the like. For instance, the third European anti-money laundering Directive (now part of UK law) allows accountants to have closed user groups. The network 10 can be adapted to transmit restricted data relating to SARs or Consents to the closed user group.

Feedback is an important aspect for closed user groups. For instance, closed user groups could be given access to the meta data of processed SARs.

The network may comprise the proprietary computer systems, databases or files of the FSPs 20, the FIU 30 and investigative agencies 40. This federated system allows each body to use their own dedicated systems to carry out their function but still benefit from the advantages of the network 10. Alternatively, the network 10 could be a centralised system which is accessible by the FSPs 20, FIU 30 and the investigative agencies 40. The network could be partly centralised and partly federated.

Access to the network may be via application software on individual computers. The application may be on a different physical system from one or more of the databases. This can be an advantage. A 32-bit system could be used for the application and a 64-bit system for the database. This is important since in a Windows environment there is only a 4 GB address bus while on a 64-bit system there is a 1 TB address bus.

A user of the network 10 can carry out a search of existing data stored on the network 10. The network 10 includes a search engine which is adapted to search structured or unstructured data. The search engine first denormalises the data to generate one or more data strings but preserving the relationships of structured data. The denormalised data is stored to memory within optimised tables and a full text catalog search is performed on the stored denormalised data. Unstructured data for the purposes of searching is stored “as-is” with an associated full-text catalog.

FIG. 3 shows a tree structure for possible searching using the search engine. A first search S1 can be carried out using a first criterion C1 to produce a first set of results S1 with C1. The user can then perform a second search S1.2 on the first set of results S1 with C1 using a second criterion C1.2 to produce a second set of results S1.2 with C1.2. The search engine allows further searches S1.2.1 to be carried out on the second set of results S1.2 with C1.2 using a third criterion C1.2.1 to produce one or more third sets of results S1.2.1 with C1.2.1. There is no limit to the depth or breadth of this structure.

This tree structure is displayed to the user so that the user can readily keep track of which searches have been performed. Furthermore, the tree structure is navigable by the user. By selecting a particular displayed search box, the search criterion used and the results are displayed to the user.

The activities of allocating/prioritising work, searching and matching have conventionally been treated and implemented as separate processes. Often, a user over time may start to recognise items such as names, addresses, bank account numbers, email addresses, or the like. It is desirable that the system can assist and encourage the user in this recognition process.

The invention allows the integration of allocation, searching and match results together. A “loop” is created which the user can navigate around as many times as required. The following three examples illustrate this feature.

### EXAMPLE 1

A user has been allocated 10 SARs. The user can:
1. Request the system to show how these SARs are linked. The system then displays the match results for these SARs.
2. After reviewing the match results for these SARs, the user may select some items of interest, such as a telephone number, an address and an email.
3. The user can then ask the system to perform a search for these three items. This may yield a different set of SARs than the original set, most likely a superset.
4. The user could now optionally do a search-within-a-search to further narrow down the set of SARs from this superset to a subset.
5. The user could then go back to step 1 above and repeat the process until a number of SARs have been identified which have a relationship worthy of investigation, such as that they appear to be part of an Organised Crime Network (OCN).

### EXAMPLE 2

The user could start with “Search Results” where the user has searched for SARs with a specific address and this has brought back, say, 15 SARs.
1. The user could then ask how these SARs are linked and the system would then display the match results for these SARs.
2. After reviewing the match results for these SARs, the user may pick out some items of interest, such as a telephone number, a company name with company number and an email.
3. The user can then ask the system to search for these items. This may yield a different set of SARs than the original set, most likely a superset.
4. The user could now optionally do a search-within-a-search to further narrow down the set of SARs from this superset to a subset.
5. The user could then go back to step 1 and repeat the process until a number of SARs have been identified which have a relationship worthy of investigation, such as that they appear to be part of an OCN.

### EXAMPLE 3

The user could start with “Match Results” where the user is reviewing the match results for a SAR.
1. After reviewing the match results for this SAR, the user may pick out some items of interest such as a telephone number and an email.
2. The user can then ask the system to search for these items. This may yield a different set of SARs than the original set, most likely a superset.
3. The user could now optionally do a search-within-a-search to further narrow down the set of SARs from this superset to a subset.
4. The user could then go back to step 1 and repeat the process until a number of SARs have been identified which have a relationship worthy of investigation, such as that they appear to be part of an OCN.

In each example above, it is possible that the activities of an OCN have been discovered. The process of how the OCNs have been discovered could then be reviewed. This could then lead to enhancements being made to the Matching Engine. OCN extensions that could then try to automatically spot OCNs based on previous patterns.

An Online analytical processing (OLAP) cube-like database could be used rather than a traditional Online transaction processing (OLTP) database. The database may reside on a separate dedicated server. An OLAP cube is a data structure that allows fast analysis of data. It can also be defined as a data structure having the capability of manipulating and analyzing data from multiple perspectives. The arrangement of data into cubes can overcome a limitation of relational databases which is that they are not always well suited for near instantaneous analysis and display of large amounts of data. Instead, they are better suited for creating records from a series of transactions known as On-Line Transaction Processing (OLTP). Although many report-writing tools exist for relational databases, these are slow when the whole database must be summarized.

Whilst specific embodiments of the present invention have been described above, it will be appreciated that departures from the described embodiments may still fall within the scope of the present invention.

1-60. (canceled)

61. An apparatus adapted to process and store data relating to a suspicious activity, the apparatus comprising:
inputting means for inputting the data;
a memory for storing the data; and
a processor for processing the data and storing the data to memory,
wherein the processor is adapted to match the inputted data with existing data which has previously been stored to memory or existing data stored at another source.

62. An apparatus as claimed in claim 61, wherein the processor is adapted to access existing data stored at a source external to the apparatus to perform the match.

63. An apparatus as claimed in claim 61, wherein the inputting means is adapted to allow the inputting of a batch of data relating to a suspicious activity and the processor is adapted to match data being added with data contained in the batch of data.

64. An apparatus as claimed in claim 61, wherein the processor is adapted to match the inputted data with existing data at the time of adding the inputted data.

65. An apparatus as claimed in claim 61, wherein the apparatus is adapted to allow a user to specify the matching criterion used by the processor, and wherein the matching criterion comprises one or more of a main subject, an associated subject, a financial account number, or a subject identifier such as a passport number, telephone number or email address.

66. An apparatus as claimed in claim 61, wherein the apparatus is adapted to match data in a first field of the inputted data with data in a second field of the existing data.

67. An apparatus as claimed in claim 61, wherein the processor is adapted to perform an exact match of inputted data with existing data or to match data that meets one or more similarity criteria.

68. An apparatus as claimed in claim 67, wherein the or each similarity criterion comprises a fuzzy start or end or text, phrasing, data proximity, status, a date or date range, synonyms, inflectional wording or geographical proximity.

69. An apparatus as claimed in claim 61, wherein the apparatus is adapted to assign a score to the inputted data based upon the degree of matching with existing data.

70. An apparatus as claimed in claim 69, wherein the score is determined using one or more factors comprises a financial value relating to the inputted data, a total financial value relating to both the inputted data and matched existing data, the type of match or the age of the suspicious activity.

71. An apparatus as claimed in claim 69, wherein the apparatus is adapted to prioritize the inputted data based upon the degree of matching with existing data.

72. An apparatus as claimed in claim 71, wherein the apparatus is adapted to prioritize the inputted data based upon the assigned score.

73. An apparatus as claimed in claim 61, wherein the apparatus is adapted to transmit or display matched data to one or more users, the matched data being transmitted or displayed in the order of the assigned score, asset value, age or status.

74. An apparatus as claimed in claim 61, wherein the apparatus is adapted to categorize matched data by how the data is matched.

75. An apparatus as claimed in claim 74, wherein the apparatus is adapted to transmit or display matched data to a user based on the category of the matched data and a designation of the user.

76. An apparatus as claimed in claim 61, wherein the inputting means is adapted to receive structured data, and the processor is adapted to process the structured data to denormalize the data.

77. An apparatus as claimed in claim 76, wherein denormalizing the data comprises generating one or more data strings corresponding to the structured data.

78. An apparatus as claimed in claim 76, wherein denormalizing the data includes preserving the relationships of the structured data.

79. An apparatus as claimed in claim 77, wherein the processor is adapted to delete duplicate data strings.

80. An apparatus as claimed claim 76, wherein the denormalized data is stored within optimized tables in memory.

81. An apparatus as claimed in claim 61, wherein the processor is adapted to carry out a full text catalog search to match inputted data with existing data.

82. An apparatus as claimed in claim 61, wherein the inputting means is adapted to receive unstructured free text data.

83. An apparatus as claimed in claim 82, wherein the processor is adapted to use regular expressions to extract tokens from the unstructured free text data.

84. An apparatus as claimed in claim 83, wherein the processor is adapted to delete duplicate tokens.

85. An apparatus as claimed in claim 83, wherein the tokens are stored within optimized tables in memory.

86. An apparatus as claimed in claim 61, wherein the apparatus includes a search engine for searching existing data, and wherein the search engine is adapted to search structured or unstructured data.

87. An apparatus as claimed in claim 86, wherein the search engine is adapted to denormalize the data by generating one or more data strings corresponding to the structured data.

88. An apparatus as claimed in claim 87, wherein denormalizing the data includes preserving the relationships of the structured data.

89. An apparatus as claimed in claim 87, wherein the denormalized data is stored within optimized tables in memory.

90. An apparatus as claimed in claim 76, wherein the search engine is adapted to allow a first search to be carried out using a first criterion to produce a first set of results, and to allow one or more second searches to be carried out on the first set of results using a second criterion to produce a second set of results.

91. An apparatus as claimed in claim 90, wherein the search engine is adapted to allow one or more subsequent searches to be carried out on the second set of results using one or more third criteria to produce one or more third sets of results.

92. An apparatus as claimed in claim 90, wherein the search and/or associated criterion are displayed to the user in a manner that indicates the relationship between the searches.

93. An apparatus as claimed in claim 92, wherein the search and/or associated criterion are displayed to the user as a tree structure, the tree structure being navigable by the user to display the results of a user selected search and/or criterion.
